(19) United States
(12) Patent Application Publication
(10) Pub. No.: US 2024/0092142 A1
(43) Pub. Date: Mar. 21, 2024

(54) AIR CONDITIONING SYSTEM FOR A VEHICLE

(71) Applicants: HYUNDAI MOTOR COMPANY, Seoul (KR); KIA CORPORATION, Seoul (KR)

(72) Inventor: Min Han Kim, Anyang-si (KR)

(73) Assignees: HYUNDAI MOTOR COMPANY, Seoul (KR); KIA CORPORATION, Seoul (KR)

(21) Appl. No.: 18/102,374

(22) Filed: Jan. 27, 2023

(30) Foreign Application Priority Data
Sep. 16, 2022 (KR) 10-2022-0117114

(51) Int. Cl. B60H 1/00

(52) U.S. Cl. CPC B60H 1/00678; B60H 1/00028; B60H 1/00835; B60H 2001/00085; B60H 2001/00185

(57) ABSTRACT

An air conditioning system includes an air conditioning unit that includes an introduction part that introduces air, a plurality of temperature adjustment parts that cool or heat introduced air, and a discharge part that discharges cooled or heated air to an inside of the vehicle. The air conditioning system further includes an outdoor duct connected to a discharge-part side of the air conditioning unit and extending toward an outdoor side of the vehicle to discharge the cooled or heated air to an outside of the vehicle. Additionally, the air conditioning system includes an outdoor door provided on the outdoor duct or on the discharge part of the air conditioning unit around the outdoor duct to control air flow through the outdoor duct.

### CROSS REFERENCE TO RELATED APPLICATION

The present application claims priority to Korean Patent Application No. 10-2022-0117114, filed on Sep. 16, 2022, the overall contents of which are incorporated herein for all purposes by this reference.

### BACKGROUND

### Technical Field

The present disclosure relates to an air conditioning system for a vehicle. More particularly, the present disclosure relates to an air conditioning system for a vehicle, which allows an air conditioning function of a vehicle to be used outside the vehicle in an outdoor living environment where outdoor activities take place. By applying a structure that connects an air conditioning unit and an outdoor duct extending toward an outdoor side of the vehicle, air conditioning may be used outside of a vehicle. Furthermore, the present disclosure relates to an air conditioning system for a vehicle that may set and control air conditioning outside the vehicle using a smartphone application.

### Description of the Related Art

Recently, as demand for untact (e.g., off the grid) travel increases, outdoor activities such as camping or car camping are also increasing. The biggest factor limiting outdoor activities is temperature, and an air conditioning function controlling the temperature is essential for outdoor activities in winter or summer. Therefore, it is necessary to provide a separate air conditioning device in a tent that may be used during outdoor activities such as camping.

Further, in several outdoor activities, such as car camping, activities in the vehicle are inconvenient due to restrictions depending on the height and length of the vehicle. Additionally, smoke and odors may contaminate the interior material of the vehicle when a user is cooking food in the vehicle. Thus, it is common to install an independent tent outside the vehicle to enjoy camping and only sleep inside the vehicle. Particularly in the case of an internal combustion engine vehicle, there are restrictions such as environmental pollution due to idling, noise problems, or fuel consumption.

The foregoing is intended merely to aid in the understanding of the background of the present disclosure, and is not intended to mean that the present disclosure falls within the purview of the related art that is already known to those having ordinary skill in the art.

### SUMMARY

Given the problems of the related art described above, there is a need for a method for utilizing an air conditioning function of a vehicle in an independent tent outside of the vehicle.

Accordingly, the present disclosure has been made keeping in mind the above problems occurring in the related art. An objective of the present disclosure is to provide an air conditioning system for a vehicle that allows an air conditioning function of a vehicle to be used outside the vehicle in an outdoor living environment where outdoor activities take place. The air conditioning system for the vehicle may be used outside of the vehicle by applying a structure that connects an air conditioning unit and an outdoor duct extending toward an outdoor side of the vehicle. Thus, the air conditioning system for the vehicle may solve the problem of controlling the inside temperature of a tent when using the tent for outdoor activities such as camping or car camping. Furthermore, the air conditioning system may set and control air conditioning outside the vehicle using a smartphone application, making it easy to control temperature.

In order to achieve the objective of the present disclosure, the present disclosure provides an air conditioning system for a vehicle, including an air conditioning unit that includes an introduction part that introduces air, a plurality of temperature adjustment parts that cool or heat introduced air, and a discharge part that discharges cooled or heated air to an inside of the vehicle. The air conditioning system further includes an outdoor duct connected to a discharge-part side of the air conditioning unit and extending toward an outdoor side of the vehicle to discharge the cooled or heated air to an outside of the vehicle. Furthermore, the air conditioning system includes an outdoor door provided on the outdoor duct or on the discharge part of the air conditioning unit around the outdoor duct to control air flow through the outdoor duct.

The air conditioning system may further include a controller configured to control an operation of the outdoor door.

The controller may open the outdoor door to discharge the cooled or heated air through the outdoor duct to the outside of the vehicle when an operating condition is satisfied and an outdoor mode is input.

The operating condition may include at least one of a vehicle starting state, a battery charging state, an air conditioning setting state, and a vehicle driving state.

The controller may determine that the operating condition is satisfied when a state where the start of the vehicle is off, a state where the battery is charged beyond a reference value, a normal connection state with the air conditioning unit, and a vehicle parking state are all satisfied.

The controller may close the outdoor door to prevent the air from being discharged to the outside of the vehicle when an outdoor mode is released.

When an indoor/outdoor mode is input to discharge air cooled or heated in the air conditioning unit to the inside and outside of the vehicle, the controller may open the indoor doors and the outdoor door to discharge the cooled or heated air through an indoor duct or the outdoor duct to the inside and outside of the vehicle.

The controller may determine whether to use the air conditioning unit and may decide whether to monitor an indoor or outdoor temperature of the vehicle according to a determined result.

The controller may determine a battery charging state and may decide whether to issue a warning or an alarm inside the vehicle according to a determined result.

The air conditioning system may further include a display part configured to display an outdoor door operation control state of the controller and an air conditioning state.

The air conditioning system may further include a duct adapter configured to connect the air conditioning unit and the outdoor duct and introduce air discharged from the air conditioning unit into the outdoor duct.

The air conditioning system may further include a fastening buckle provided on an end of the outdoor duct to connect the duct adapter and the outdoor duct through a fitting structure.

The air conditioning system may further include a discharge path connected to an outside of the outdoor duct to extend a path through which air is discharged to the outside. Additionally, the discharge path may be formed (e.g., configured) to adjust a discharge direction to the outside.

The discharge path may be formed in a shape of bellows to adjust a length of the path through which air is discharged to the outside.

The air conditioning system may further include an outdoor heater provided on an end of the discharge path to control a temperature outside the vehicle by reheating the air discharged to the outside of the vehicle.

The controller may determine whether a target temperature is reached and may decide whether to operate the outdoor heater according to a determined result.

The air conditioning system may further include a temperature sensor provided on an end of the discharge path to measure a temperature of air discharged to the outside of the vehicle.

The air conditioning system may further include a communication controller configured to communicate with the temperature sensor and control an outdoor temperature and an air volume.

The communication controller may control the outdoor temperature and the air volume by setting an outdoor mode or an indoor/outdoor mode depending on the temperature of air measured by the temperature sensor.

The air conditioning system may further include a cowl top cover provided on the discharge-part side of the air conditioning unit and configured to have an internal space formed thereunder. Furthermore, the outdoor duct may be connected to the discharge-part side of the air conditioning unit in the internal space when the cowl top cover is removed.

According to the present disclosure, an air conditioning system for a vehicle allows an air conditioning function of a vehicle to be used outside the vehicle even in an outdoor living environment where outdoor activities take place. The air conditioning system for the vehicle may be used outside of the vehicle by applying a structure that connects an air conditioning unit and an outdoor duct extending toward an outdoor side of the vehicle. Thus, the air conditioning system for the vehicle may solve the problem of controlling the inside temperature of a tent when using a tent for outdoor activities such as camping or car camping. Furthermore, the air conditioning system may set and control air conditioning outside the vehicle using a smartphone application, thus making it easy to control temperature.

The present disclosure is not limited to the above-mentioned effects. Other effects of the present disclosure should be clearly understood by those having ordinary skill in the art from the following description.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a diagram illustrating the configuration of an air conditioning system for a vehicle according to an embodiment of the present disclosure;

FIG. 2 is a diagram illustrating a separate structure on which a duct adapter and an outdoor duct for an outdoor-mode operation are mounted;

FIGS. 3 and 4 are diagrams illustrating an air flow control method of an outdoor door constituting the air conditioning system for the vehicle;

FIG. 5 is a diagram illustrating a display part that displays an outdoor-door operation control state and an air conditioning state;

FIG. 6 is a flowchart illustrating an operating condition of an outdoor mode through an outdoor operation control of a controller;

FIG. 7 is a diagram illustrating a flow in which air is heated while passing through a temperature adjustment part of a plurality of temperature adjustment parts and then discharged to the outside, along cross-section A;

FIG. 8 is a diagram illustrating a flow in which air is cooled while passing through another temperature adjustment part of a plurality of temperature adjustment parts and then is discharged to the outside;

FIG. 9 is a diagram illustrating a flow in which air is discharged to the interior and exterior of the vehicle when an indoor/outdoor mode for discharging air to the interior and exterior of the vehicle is input;

FIG. 10 is a flowchart illustrating an outdoor mode or indoor/outdoor mode control method through the vehicle indoor and outdoor monitoring of the controller;

FIG. 11 is a diagram illustrating a structure in which the duct adapter is sealed in a general driving mode of the vehicle;

FIG. 12 is a diagram illustrating a state in which a cowl top cover is removed and the outdoor duct is connected to a discharge-part side of the air conditioning unit in an internal space, along cross-section B:

FIG. 13 is a diagram illustrating an embodiment in which air is not discharged to the outside when the outdoor mode is released;

FIG. 14 is a diagram illustrating a fastening buckle that connects the outdoor duct and the duct adapter to each other;

FIG. 15 is a diagram illustrating a discharge path that is connected to the outside of the outdoor duct;

FIG. 16 is a flowchart illustrating a method of controlling an outdoor temperature by reheating air discharged to the outside through an outdoor heater;

FIG. 17 is a flowchart illustrating a system control method of the controller according to the battery charging state of the vehicle; and

FIG. 18 is a diagram illustrating the shape of an end of the discharge path of FIG. 15 that is directly connected to the interior.

### DETAILED DESCRIPTION

Hereinafter, the embodiments of the present disclosure are described in detail with reference to the accompanying drawings. The same reference numerals are used throughout the drawings to designate the same or similar components.

Further, the terms “module,” “unit,” and the like described in this specification are given or used together for the ease of the description, but do not have a distinct meaning or function.

When it is determined that the detailed description of the known art related to the present disclosure may obscure the gist of the disclosure, the detailed description thereof is omitted. Further, it is to be understood that the accompanying drawings are merely for making those having ordinary skill in the art easily understand the embodiments disclosed herein. The present disclosure is intended to cover not only embodiments disclosed herein, but also various alternatives, equivalents, or substitutes that fall within the spirit and scope of the present inventive concept. Although the terms “first,” “second,” and the like may be used herein to describe various elements, these elements should not be limited by these terms. These terms are only used to distinguish one element from another element.

It should be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present.

Herein, the singular forms are intended to include the plural forms as well, unless the context clearly indicates otherwise.

It should be further understood that the terms “comprise,” “include,” “have,” and the like when used in this specification, specify the presence of stated features, integers, steps, operations, elements, components, and/or combinations thereof but do not preclude the presence or addition of one or more other features, integers, steps, operations, elements, components, and/or combinations thereof. Furthermore, when a component, device, element, or the like of the present disclosure is described as having a purpose or performing an operation, function, or the like, the component, device, or element should be considered herein as being “configured to” meet that purpose or to perform that operation or function.

A controller may include: a communication device that communicates with another controller or a sensor to control a desired function; a memory that stores an operating system, logic command or input/output information; and one or more processors that perform decision, calculation, determination, and the like required for controlling a desired function.

According to an embodiment of the present disclosure, it is proposed to use an air conditioning function of a vehicle outside the vehicle, even in an outdoor living environment where outdoor activities take place. An air conditioning function of a vehicle may be used outside the vehicle by applying a structure that connects an air conditioning unit and an outdoor duct extending toward an outdoor side of the vehicle.

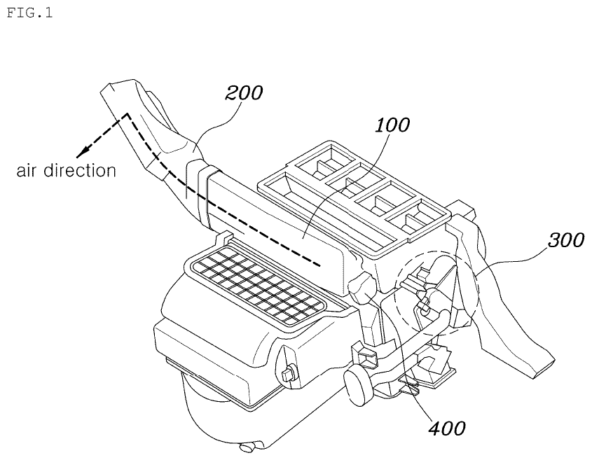

FIG. 1 is a diagram illustrating the configuration of an air conditioning system for a vehicle according to an embodiment of the present disclosure. FIG. 1 mainly shows components related to an embodiment, and an actual system may be implemented to include more or less components.

Referring to FIG. 1, an air conditioning system for a vehicle, according to an embodiment, may include an air conditioning unit 300, an outdoor duct 200, an actuator 400, and a duct adapter 100.

The system may have a duct structure connected to the outside, and may have the actuator 400 and an outdoor door 21 to control whether to discharge air to the outside. The air flow control through the outdoor duct 200 of the outdoor door 21 is performed in an outdoor mode environment for reasons such as a reduction in the efficiency of a blower due to a decrease in indoor pressure of the vehicle and an increase in the opening force of a vehicle door. The outdoor mode is described below.

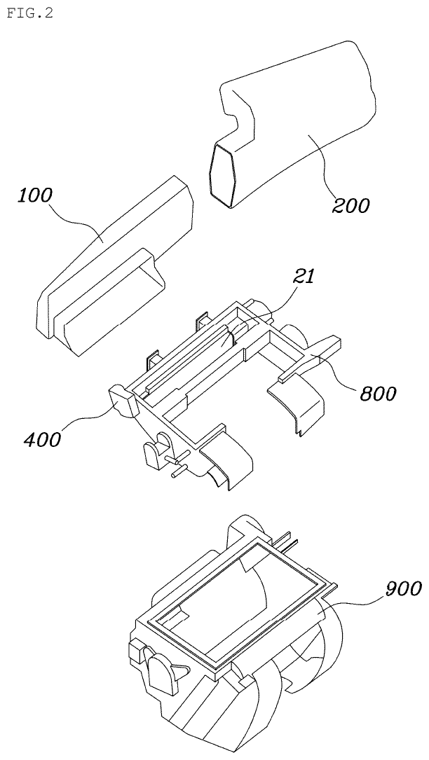

FIG. 2 is a diagram illustrating a separate structure 800 on which the duct adapter 100 and the outdoor duct 200 for an outdoor-mode operation are mounted. When the air conditioning system for the vehicle is configured to allow the air conditioning function to be used outside the vehicle, which may lead to an increase in the purchasing price of the vehicle, it is necessary to allow a consumer to select an outdoor air conditioning option in a vehicle purchase stage. If the number of systems of the air conditioning system is increased to give a consumer a degree of freedom in option selection, even in the vehicle manufacturing process, such options may increase investment costs and may be inefficient in terms of process operation. Therefore, the system is configured to connect or disconnect the outdoor duct 200 to or from an upper portion of a housing 900, thus increasing the degree of freedom of the operation but lowering investment costs. To be more specific, as shown in FIG. 2, an upper end of the Heating, Ventilation, and Air Conditioning (HVAC), i.e., the air conditioning unit 300, is configured to be separated and dualized, so it is possible to increase the degree of freedom of operation. A lower end of the HVAC may be equipped with temperature adjustment parts (e.g., temperature control elements) such as an evaporator 10 or a heater 13, while a system for the outdoor mode and a system that does not support the outdoor mode may be separately operated in an upper end of the HVAC.

In the present disclosure, the air conditioning unit 300 may include an introduction part 20 that introduces air, a plurality of temperature adjustment parts 10 and 13 that cool or heat the introduced air, and a discharge part 30 that discharges the cooled or heated air. The introduction part 20 may adjust an air flow to introduce the air into the air conditioning unit 300. The temperature adjustment parts 10 and 13 may include the evaporator 10 that cools the introduced air and the heater 13 that heats the introduced air. Further, indoor doors may discharge cooled or heated air to the interior of the vehicle through the evaporator 10 or the heater 13, respectively, and may include all of a DEF flap 22, a C/PAD flap 23, a shower duct flap 24, and a heater flap 25.

Further, the outdoor duct 200 may be connected to a discharge-part side of the air conditioning unit 300, and may extend toward the outdoor side of the vehicle to discharge the cooled or heated air to the outside of the vehicle. The air conditioning unit 300 is mainly disposed at a front of the vehicle, and the outdoor duct 200 is advantageously located on a front side of the vehicle so as to minimize transmission efficiency and a loss rate.

For example, the outdoor duct 200 may be connected to a cowl top cover 700 that is provided on the discharge-part side of the air conditioning unit 300. The air conditioning system according to an embodiment may form a flow path along a cowl at a lower end of a defrost duct branch, and may form a flow path through which air flows to the cowl. If the outdoor duct 200 is configured to be separately connected to the air conditioning system, material cost and investment cost may be reduced, and it may be easy to consider horizontal deployment with a vehicle to which the outdoor duct 200 is not applied.

The air conditioning system according to an embodiment may form a discharge path through which air is discharged before branching the path of the defrost duct. Since the vehicle necessarily has a separate defrost function for defrosting a windshield glass, and the air conditioning unit and the blower have the defrost function, it may be most advantageous to simplify the flaps (the DEF flap 22, the C/PAD flap 23, the shower duct flap 24, and the heater flap 25) (i.e., the indoor doors), which are complicated, to configure the outdoor duct 200 before the defrost branch.

There are several advantages by forming the discharge path through which air is discharged before the path of the defrost duct is branched, as described herein.

First, operational efficiency is increased with respect to air intake and discharge pressure. In the present disclosure, since air is discharged to the outside of the vehicle in the outdoor mode, a pressure difference is lowered, and air can be efficiently sucked and discharged due to the lowered pressure difference. Since a discharge area forms atmospheric pressure, which is a pressure lower than that of the vehicle that is a “closed system,” the discharge efficiency of the blower can be increased. The indoor pressure of the vehicle may be lowered in the indoor mode. Thus, in this case, it is necessary to switch the mode to the outdoor mode.

Further, the size of the blower may be maintained in an outdoor vehicle such as a sports utility vehicle (SUV), a multi-purpose vehicle (MPV), or a crossover utility vehicle (CUV). The outdoor vehicle is generally formed of a tailgate type, and most outdoor vehicles have three rows and a luggage space. However, considering the internal volume of an outdoor tent, the size of the blower may be maintained, and the blower of a third row may be additionally used if necessary.

Further, the unique properties of an outdoor space may be used. Since an outdoor space such as a tent has no complex structure compared to the interior of the vehicle, there is less resistance to air flow. Therefore, it is possible to sufficiently control the temperature even with the air conditioning performance of the vehicle.

Further, the connecting position of the outdoor duct 200 of a discharge path 600 that is described below may be freely selected. Since the discharge path 600 may be formed (e.g., configured) in the shape of bellows, a user may very freely select an air discharge location. A duct may be configured such that the cooled air falls from above and the heated air rises from below.

Further, in an outdoor situation, the vehicle may be directly connected to a local living space such as a sleeping bag to use in the space. In particular, it is possible to actively and continuously discharge air directly to the local living space compared to a hot pack (e.g., heat pads, hand warmers, and the like) with low sustainability.

Further, since the indoor temperature may be actively set through the controller, it may be easy to develop passive outdoor products from which air may leak or in which a change in outdoor temperature may be minimized.

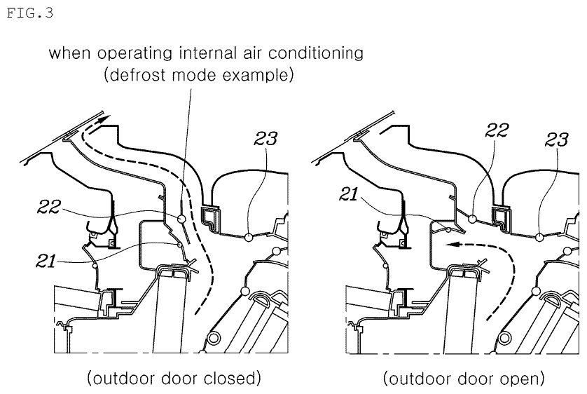

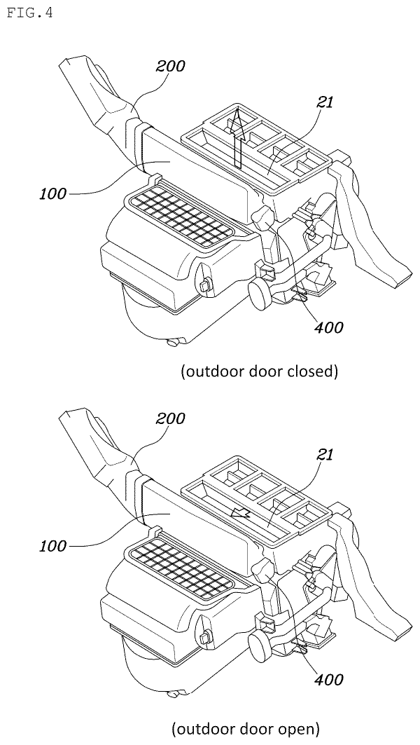

FIGS. 3 and 4 are diagrams illustrating an air flow control method of the outdoor door 21 constituting the air conditioning system for the vehicle.

Referring to FIGS. 3 and 4, it can be seen that the outdoor door 21 is provided on the outdoor duct 200 or on the discharge part 30 of the air conditioning unit 300 around the outdoor duct 200 to control the air flow through the outdoor duct 200. The outdoor door 21 may control the air flow through the actuator 400. The “outdoor door closed” (e.g., left) diagram of FIG. 3 and the “outdoor door closed” (e.g., top) diagram of FIG. 4 show a state in which all defrost operations are performed to condition indoor air when the outdoor door 21 is closed. In contrast, the “outdoor door open” (e.g., right) diagram of FIG. 3 and the “outdoor door open” (e.g., bottom) diagram of FIG. 4 show a state in which the outdoor mode is input to discharge the cooled or heated air to the outside of the vehicle when the outdoor door 21 is opened. Except for the outdoor mode and the indoor/outdoor mode, the outdoor door 21 is always closed to prevent air from being discharged to the outside.

A duct adapter 100 may be further provided between the air conditioning unit 300 and the outdoor duct 200 to connect the air conditioning unit 300 and the outdoor duct 200. Thus, the duct adapter 100 introduces air discharged from the air conditioning unit 300 into the outdoor duct 200. It is efficient to separately assemble the duct adapter 100 outside the vehicle in consideration of the assemblability (i.e., ability of being assembled) and airtightness of the outdoor duct 200. The duct adapter 100 may change the air discharge direction from the longitudinal direction of the vehicle to the widthwise direction of the vehicle connected to the outdoor duct 200. Additionally, the duct adapter 100 may allow the outdoor duct 200 to be more easily connected to the discharge-part side of the air conditioning unit 300.

Further, the duct adapter 100 may be shared with and horizontally deployed from other vehicles by changing only the shape of the outdoor duct 200 connected to the duct adapter 100 according to layout and package conditions. Thus, the material cost and investment cost of the duct adapter 100 can be reduced. Considering that dew condensation may occur in the duct adapter 100 due to a difference between the outdoor temperature and the temperature of the air conditioning system, the duct adapter 100 may further include a drain hose (not illustrated). The drain hose provides a differential head h by forming a ramp to allow dew condensation to flow, and extends downwards along the outer surface of the air conditioning unit 300.

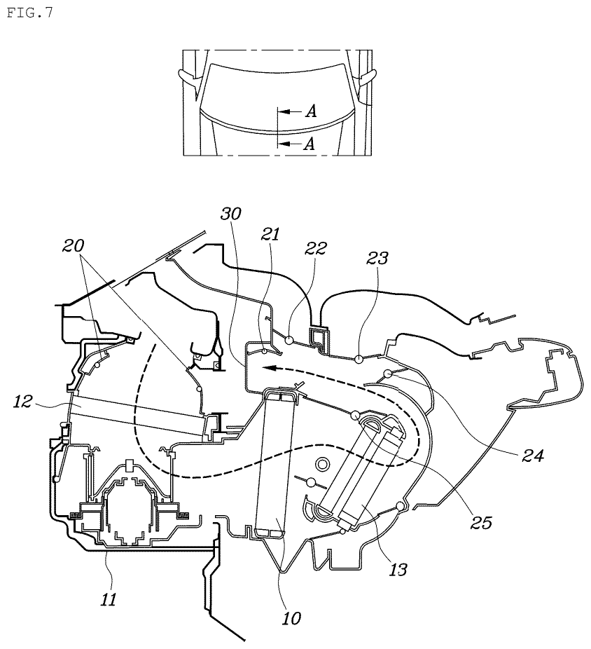

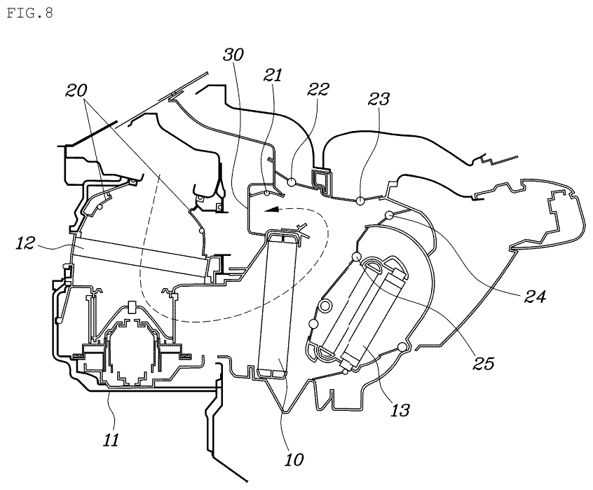

FIGS. 7 and 8 show a cross-section A, and are diagrams illustrating the flow in which air is heated and cooled while passing through the temperature adjustment parts 10 and 13, respectively, and then discharged to the outside.

Referring to FIGS. 7 and 8, the controller may control the operation of the outdoor door 21 so that the outdoor duct 200 adjusts the air flow. The controller may control both the indoor doors and the outdoor door 21, and may be classified into the outdoor mode and the indoor/outdoor mode by selectively controlling the indoor doors and the outdoor door 21.

First, when an operating condition is satisfied and the outdoor mode is input, the controller may open the outdoor door 21 to discharge the cooled or heated air through the outdoor duct 200 to the outside of the vehicle. The outdoor mode may be referred to as a Vehicle to Outdoor (V2O) mode. As shown in FIG. 7, when the outdoor mode is input into the controller, all flaps are closed except for the flap for the air conditioning function, the introduction part 20, and the outdoor door 21. As shown in FIG. 7, in the case of a heater mode of the outdoor mode in which the heated air is discharged, the introduced air is heated while sequentially passing through an air filter 12 and the temperature adjustment parts 10 or 13, and then is moved to the outdoor door 21. Since a flow path is closed by the DEF flap 22, the C/PAD flap 23, and the shower duct flap 24, only the flow path connected to the outside is opened so that the heated air may be discharged without any loss.

Further, as shown in FIG. 8, in the case of an air conditioner mode of the outdoor mode in which the cooled air is discharged, the introduced air is cooled while sequentially passing through the air filter 12 and the temperature adjustment parts 10 or 13, and then is moved to the outdoor door 21. Similarly to the heater mode of FIG. 7, since the flow path is closed by the DEF flap 22, the C/PAD flap 23, and the shower duct flap 24, only the flow path connected to the outside is opened so that cooled air may be discharged without any loss.

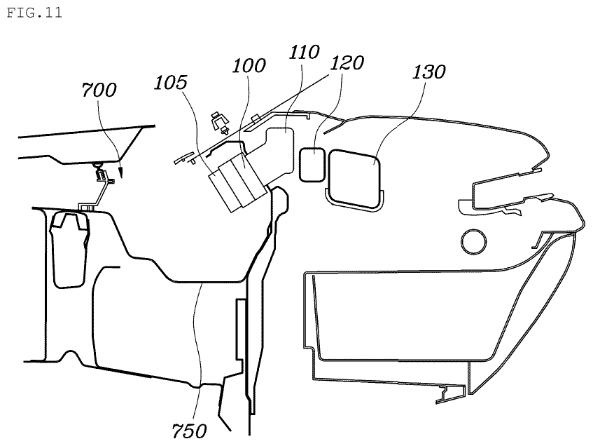

Further, FIG. 11 is a diagram illustrating a structure in which the duct adapter 100 is sealed in a general driving mode of the vehicle. When the vehicle is generally driving, the outdoor door 21 is closed because an air conditioner is used only inside the vehicle. Further, a sealing structure 105, such as a rubber grommet, may be provided, thus preventing air from being discharged from an external discharge duct 110 to the duct adapter 100. The duct adapter 100 may be further mounted to provide airtightness and conform to an external-duct-adapter mounting structure. The duct adapter 100 is configured such that a through hole faces downward, thus preparing in advance for contamination that may occur in an environment where dew condensation is introduced into the flow path or in an environment where it is snowing or raining.

On the other hand, the cowl top cover 700 may be provided on the discharge-part side of the air conditioning unit 300. Additionally, the cowl top cover may have an internal space formed thereunder. When the cowl top cover is removed, the outdoor duct 200 may be connected to the discharge-part side of the air conditioning unit 300 in the internal space.

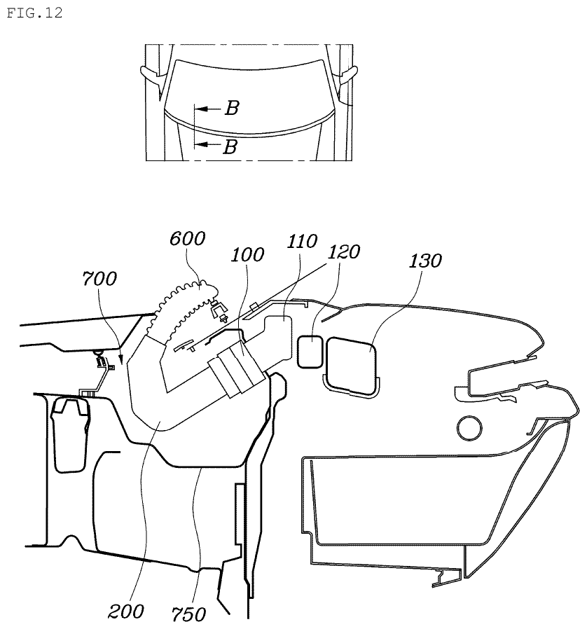

FIG. 12 is a diagram illustrating a state in which the cowl top cover 700 is removed, and the outdoor duct 200 is connected to the discharge-part side of the air conditioning unit 300 in the internal space, along cross-section B.

As shown in FIG. 12, cross-section B shows the DEF duct 120 and the C/PAD air conditioning duct 130. It can be seen that the lower portion of the internal space, defined by the cowl top cover 700, is supported by a cowl upper panel 750.

The duct adapter 100 may be connected to the external discharge duct 110, and the outdoor duct 200 may be connected to the duct adapter 100 in the internal space defined by the cowl top cover 700 to discharge air from the air conditioning unit 300. A location where air is discharged from the outdoor duct 200 may be at the lower end of the cowl top cover 700. The cowl top cover 700 may be mounted in the general driving mode and may be removed in the outdoor mode. Thus, by removing the cowl top cover 700 in the outdoor mode, the interior and exterior of the vehicle may be connected to each other.

As shown in FIG. 12, the adapter provided on the end of the outdoor duct 200 may be inserted into the internal space defined under the cowl top cover 700 to be bound thereto, and various binding structures may be applied. Since it is difficult to form the adapter and a matching part in a circular shape when they are configured in the internal space of the cowl top cover 700, a fastener structure (not illustrated) for connecting adapters of two flow paths is required. In this case, by applying an outlet port at a fender or another location, the degree of freedom of the fastener structure may be increased. When the outdoor mode is not operated, the cowl top cover 700 may form the flow path toward the air conditioning unit 300. The cowl top cover 700 may be disposed in consideration of a wiper, a link structure, and a fresh air hole.

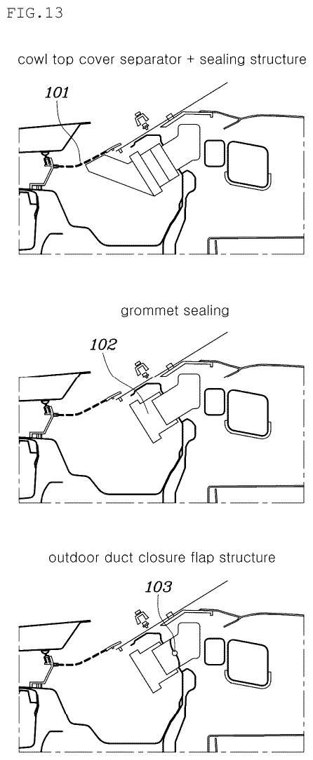

Further, FIG. 13 shows an embodiment in which air is not discharged to the outside when the outdoor mode is input (e.g., released) in the controller. The cowl top cover 700 may be configured to be partially removed, and the internal space may be formed thereunder. Thus, the air flow path may be closed through a structure 101 for sealing the duct adapter 100 in the internal space of the cowl top cover 700. Further, the air flow path may be closed through the structure for sealing an end of the duct adapter 100 using the rubber grommet 102. Finally, the air flow path may be closed by closing the outdoor door 21 to prevent air from being discharged to the outside of the vehicle. A structure for preventing air from being discharged to the outside when the outdoor mode is released is illustrative and is not limited to the herein-described structure.

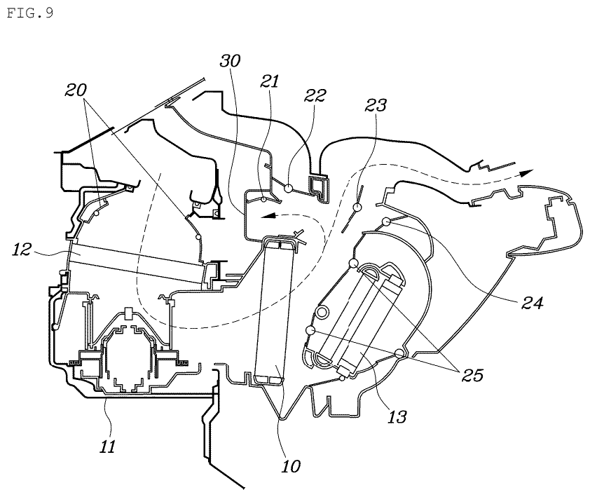

Further, when the indoor/outdoor mode is input, the controller may open the indoor doors and the outdoor door 21 to discharge the cooled or heated air through the indoor duct or the outdoor duct 200 to the inside and outside of the vehicle. Referring to FIG. 9, in the case of inputting the indoor/outdoor mode using the air conditioner in both the inside and the outside of the vehicle, the flow of air discharged to the inside and the outside of the vehicle may be checked. A user may input the indoor/outdoor mode into the controller to use the air conditioning function in both the inside and the outside of the vehicle when necessary, and the user may select the outdoor mode or the indoor/outdoor mode. The indoor/outdoor mode, which results in opening the indoor doors and the outdoor door 21, may smoothly correspond to the indoor/outdoor mode by increasing the size of the blower.

The indoor/outdoor mode may be input into the controller when a user lives or sleeps inside or outside the vehicle or when defrosting is required before the vehicle is driven while air conditioning is used outdoors. A user may input the indoor/outdoor mode by controlling the indoor doors and the outdoor door 21 using the smartphone application or the like.

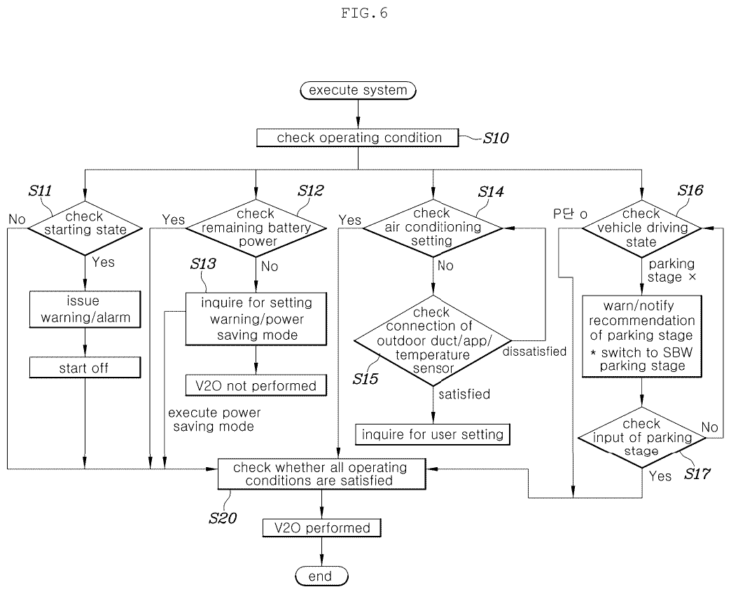

FIG. 6 is a flowchart illustrating the operating condition of the outdoor mode through the outdoor operation control of the controller.

Referring to FIG. 6, the operating condition may include a vehicle starting state, a battery charging state, an air conditioning setting state, and a vehicle driving state. First, if the air conditioning system for the vehicle is executed, the controller may check the operating condition (S10). The controller may check the starting state of the vehicle (S11), and may issue a warning and an alarm when the start is on, thus forcing the user to turn the start off (YES in S11). However, since the starting state is satisfied when the start is off (NO in S11), the controller may check whether all other operating conditions are satisfied (S20).

Further, the controller may check the battery charging state of the vehicle (S12), and may make an inquiry for setting a warning and power saving mode (S13) when it is determined that the remaining battery power is not sufficient to operate the outdoor mode (NO in S12). When the power saving mode is not set normally, the outdoor mode may not be input. However, when it is determined that the power saving mode is set and the operating condition except for the battery charging state is satisfied, the outdoor mode may be input. When it is determined that the remaining battery power is sufficient to operate the outdoor mode (YES in S12), the controller may check whether all other operating conditions are satisfied (S20).

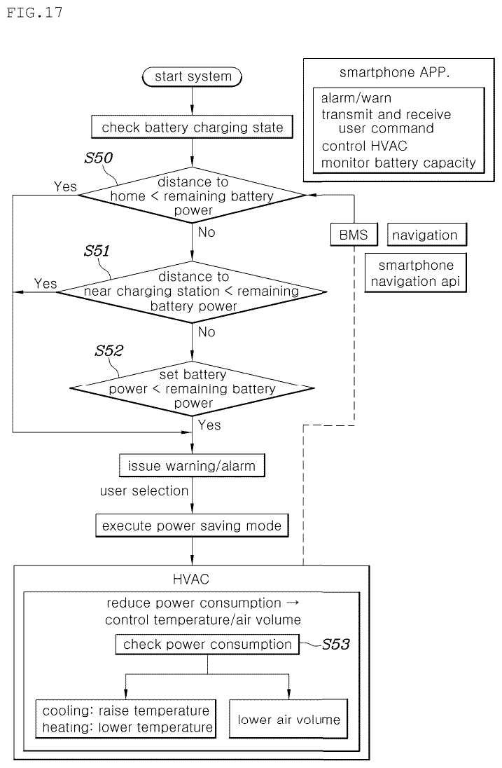

This is described in detail with reference to FIG. 17. The controller may determine a battery charging state, and may decide whether to issue a warning or trigger an alarm inside the vehicle when it is determined that the battery charging state is equal to or less than a predetermined level.

First, it may be checked whether the remaining battery power is more than the battery power needed to drive home (350). When the remaining battery power is more than the battery power required to drive home, it is possible to issue a warning or an alarm (YES in S50). When the remaining battery power is less than the battery power needed to drive home (NO in S50), it may be checked whether the remaining battery power is more than the battery power needed to drive to a nearby charging station (S51). Further, even when the remaining battery power is more than the battery power needed to drive to a nearby charging station, it is possible to issue a warning or an alarm (YES in S51).

However, when the remaining battery power is less than the battery power needed to drive to the nearby charging station (No in S51), it may be checked whether the remaining battery power is more than the battery power that is set by a user (S52). Likewise, when the remaining battery power is more than the battery power that is set by the user, it is possible to issue a warning or an alarm (YES in S52). When the warning is issued or the alarm is issued in the herein-described situation, the power saving mode of the vehicle may be executed by a user's selection. Thereafter, the controller may check power consumption (S53) and may control the temperature or air volume so as to reduce the power consumption. In the case of controlling the temperature, the set temperature may be raised during cooling, whereas the set temperature may be lowered during heating. In the case of controlling the air volume, the air volume may be lowered.

Further, the controller may check the air conditioning setting state (S14) and may check whether the hardware required for setting the outdoor mode, for example, the outdoor duct 200, the smartphone application, and an outdoor heater 1000, are connected to each other (S15). When the hardware required for setting the outdoor mode is connected, it may inquire a user: whether to use indoor air conditioning; whether to synchronize indoor air conditioning and external air conditioning; about the setting of external air conditioning temperature and air volume; and whether to switch to the outdoor mode. However, if the hardware required for setting the outdoor mode is not connected, the system may wait until the hardware is connected.

Finally, the controller may check the vehicle driving state to check whether the vehicle is set to a parking state (S16). Unless the vehicle is set to the parking state, it may give warning and display a notification recommending to switch to the parking state. Thereafter, it may be checked again whether the vehicle is set to the parking state (S17).

Therefore, when all of the states, such as: where the start of the vehicle is off; a state where the battery is charged beyond a reference value; a normal connection state with the air conditioning unit 300; and a vehicle parking state are satisfied, the controller determines that the operating condition is satisfied, so the outdoor mode may be input. The herein-described operating condition is illustrative, and the disclosure may cover all conditions for normally operating the outdoor mode without necessarily being limited thereto.

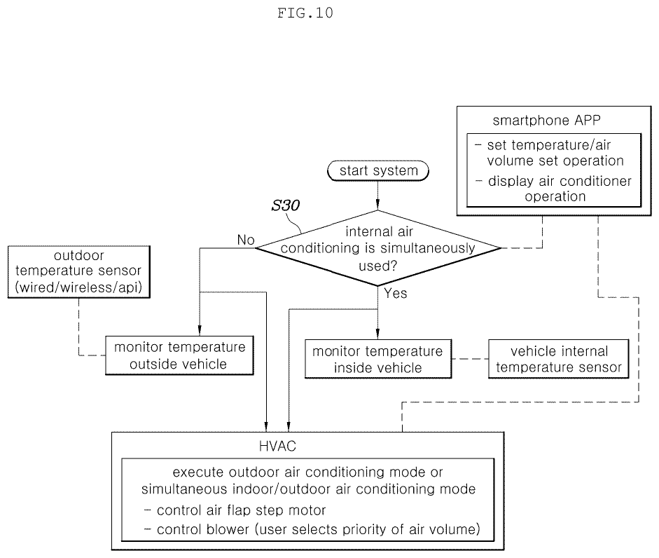

Further, FIG. 10 is a flowchart illustrating the outdoor mode or indoor/outdoor mode control method through the vehicle indoor and outdoor monitoring of the controller.

Referring to FIG. 10, the controller may receive the outdoor mode or the indoor/outdoor mode control method through the smartphone application. The controller may determine whether to use the air conditioning unit (S30), and may decide whether to monitor the indoor or outdoor temperature of the vehicle according to the determined result. The use of the air conditioning unit by the controller may be determined to determine the outdoor mode or the indoor/outdoor mode control method. The indoor temperature may be monitored through a temperature sensor inside the vehicle, while the outdoor temperature may be monitored through a temperature sensor outside the vehicle. Thus, the controller needs to monitor the indoor temperature of the vehicle when the indoor/outdoor mode is input (YES in S30). Alternatively, the controller does not need to monitor the indoor temperature of the vehicle and may instead monitor only the outdoor temperature of the vehicle when the outdoor mode is input (NO in S30). In this case, the air flow rate of the outdoor door 21 or the air volume of the blower may be controlled according to the detailed temperature setting that is input into the controller. In the indoor/outdoor mode, the priority of the air volume through the blower may be determined through a user's selection.

FIGS. 6, 10, and 17 may display the control state of the controller through the smartphone application or a display part 500.

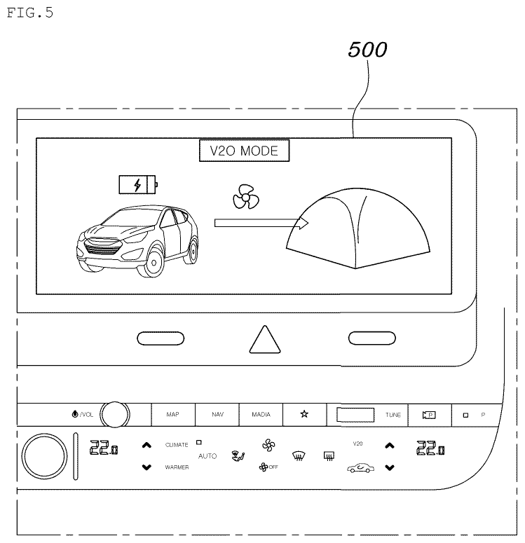

FIG. 5 illustrates the display part 500 that displays the operation control state of the outdoor door 21 and the air conditioning state. The display part 500 may display the outdoor door operation control state of the controller and the air conditioning state. Although the display part may be provided in the vehicle as shown in FIG. 5, the display part may not only display the operation control state but may also control to operate the outdoor door 21 while being carried by a user in the form of the smartphone application. Further, the connection state of the hardware forming the air conditioning unit 300 may also be displayed on the display part 500. This may solve the temperature problem inside a tent during outdoor activities, and may make it possible to set and control the air conditioning outside the vehicle using the smartphone application, thus making it easy to control the temperature. When the air conditioning is used outside the vehicle, it is very inefficient to enter the vehicle so as to control the temperature, so the display part may be controlled using the smartphone application to control the temperature of the air conditioner. Further, when using air conditioning in the electric vehicle (EV), it is necessary to display the remaining battery power as well as the battery state so that the air conditioning may be efficiently performed or controlled. When control is performed through the smartphone application, it is advantageous that unnecessary infotainment such as Audio, Video, and Navigation (AVN) in the vehicle is not activated.

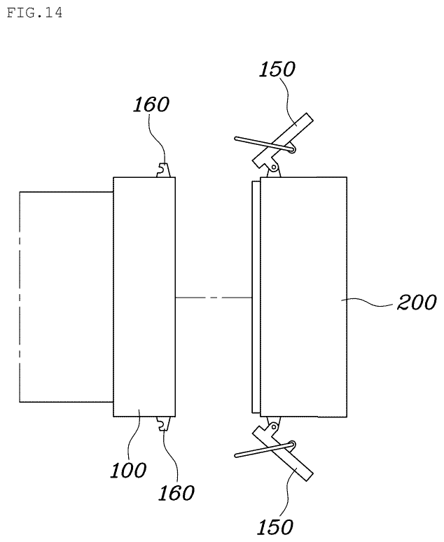

FIG. 14 is a diagram illustrating a fastening buckle 150 that connects the outdoor duct 200 and the duct adapter 100 to each other. Referring to FIG. 14, the fastening buckle 150 may be provided on an end of the outdoor duct 200, and may connect the duct adapter 100 and the outdoor duct 200 through a fitting structure 160. A structure to which each hose/duct is coupled is provided with a sealing structure or grommet for airtightness, a guide structure for minimizing the occurrence of a step during coupling, and the like. The fastening buckle 150 may be applied to both sides or one side of the outdoor duct 200. Further, a rotary buckle may also be applied to the configuration of a circular duct.

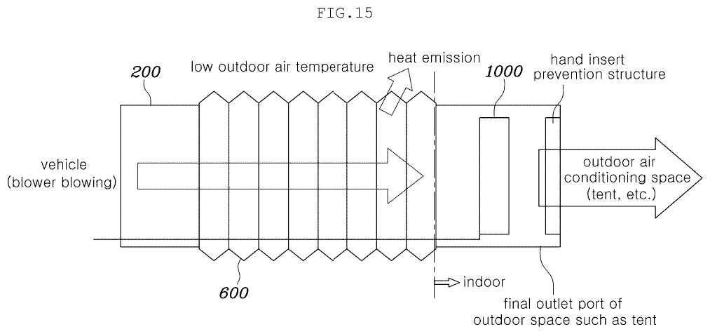

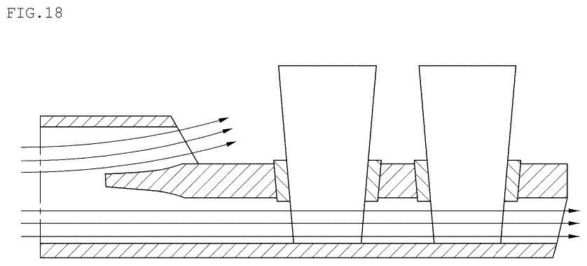

FIG. 15 is a diagram illustrating the discharge path 600 that is connected to the outside of the outdoor duct 200. FIG. 18 is a diagram illustrating the shape of an end of the discharge path 600 of FIG. 15 that is directly connected to the interior. The discharge path 600, extending the path through which air is discharged to the outside, may be connected to the outside of the outdoor duct 200 to adjust the discharge direction to the outside. The discharge path 600 may increase the degree of freedom of the length and path by applying bellows and improving the car Noise, Vibration, and Harshness (NVH). As the length of the discharge path 600 becomes shorter, there is no air flow resistance, which is advantageous. The bellows of the discharge path 600 may have various shapes. In particular, when the discharge path is not in use, a structure such as a helix or bellows that may be reduced in volume when folded to have a structure that is easy to be stored in the vehicle may be applied to have volume economy during storage. The discharge path 600 is made of a heat insulating material because cooling/heating efficiency may rapidly deteriorate depending on the outdoor temperature.

Further, a method of separately forming the discharge path 600 for each season in consideration of specifications and prices may also be considered. Subsequently, as shown in FIG. 18, a final outlet port of the discharge path 600 may be directly connected to the tent during outdoor activities to allow a person to drink cold or warm beverages. According to the heat transferred from the inside of the tent connected to the final outlet port of the discharge path 600 to the outside, the operation efficiency of air conditioning may be maximized. The current tent places the most importance on waterproof performance and weight in consideration of portability, but it is advantageous to use a material with low surface temperature conduction for the tent for auto camping. Thus, an inner covering of the tent may be formed of fabric Warm Tex material, and air is discharged into a space defined therein, thus increasing cooling/heating efficiency.

Further, a temperature sensor may be provided on an end of the discharge path 600 to measure the temperature of air discharged to the outside of the vehicle. A communication controller is configured to communicate with the temperature sensor provided on the end of the discharge path 600, thus controlling the outdoor temperature and the air volume. To be more specific, the communication controller may adjust the outdoor temperature and the air volume by setting the outdoor mode or the indoor/outdoor mode depending on the air temperature measured by the temperature sensor. The outdoor temperature may be adjusted by the outdoor heater 1000, and the air volume may be adjusted by the blower installed in the vehicle. The herein-described communication controller may refer to a communication device including the smartphone application and the AVN in the vehicle.

Temperature sensor wiring for connecting the temperature sensor should be configured to respond to an increase in length of the discharge path 600. Additionally, wiring of the same length may be applied along a frame having a spiral structure or using a helix bellows hose. In addition, a separate extension responding structure may be provided. In this case, since a wired temperature sensor is not required when measuring the temperature of an external space using the communication controller, it is not an essential element. Further, when the wired temperature sensor is applied, a separate connector connection structure may be provided on an external duct adapter side to supply power and transmit and receive a signal. Further, the air conditioning unit 300 may be controlled using data obtained through the temperature sensor. In other words, an auto mode may be used as in the vehicle, and the same operation as the vehicle is possible.

Further, air flow at low temperature may cause a sharp reduction in heating efficiency. For example, since the heating efficiency due to heat transfer may be rapidly reduced depending on the length of the path even in the air conditioning system in the vehicle, the outdoor heater 1000 may be provided on the end of the discharge path 600. The outdoor heater 1000 may be provided on the end of the discharge path 600, and may control the temperature outside the vehicle by reheating the air discharged to the outside of the vehicle. The outdoor heater 1000 may include a positive temperature coefficient (PTC) heater 13, and may support temperature and adjust the air volume through the blower in the vehicle so as to solve a problem where heating efficiency deteriorates. In this case, the internal air conditioning unit 300 and the PTC heater 13 at the final outlet port may be simultaneously used to rapidly increase temperature. The internal air conditioning unit 300 may support only the blowing of a blower motor, and a heating function may be supported using the PTC heater 13 at the final outlet port. Additionally, only the heater system 13 of the internal air conditioning unit 300 may be used. Further, when using the internal air conditioning unit 300 at a very low temperature, air heated through the internal air conditioning may be first blown. When the temperature is inevitably lowered due to outside temperature, the PTC heater 13 may be reheated to reach a target temperature.

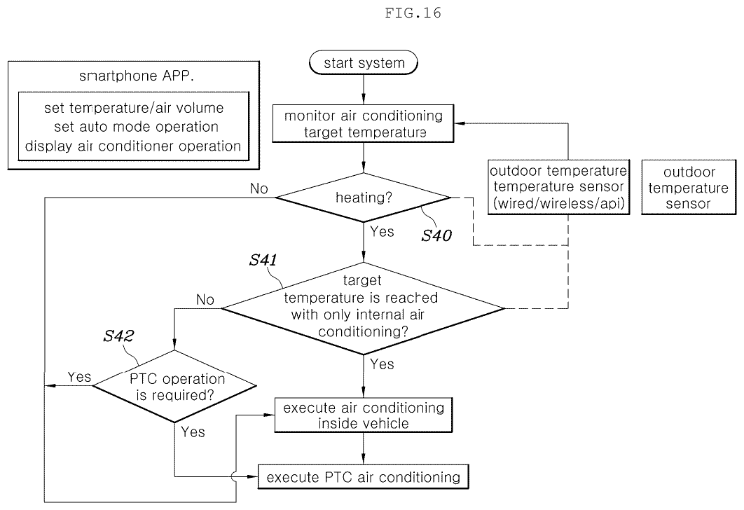

FIG. 16 is a flowchart illustrating a method of controlling an outdoor temperature by reheating air discharged to the outside through the outdoor heater 1000.

Referring to FIG. 16, the controller may monitor a set temperature through the outdoor temperature sensor, and may check whether a mode is a heater mode of the outdoor mode (S40). When it is determined that the mode is not the heater mode (NO in S40), execution is possible through the air conditioning unit 300 in the vehicle. However, when it is determined that the mode is the heater mode (YES in S40), it may be determined whether a target temperature is reached only by the operation of the outdoor door 21 (S41). If it is possible to reach the target temperature only by the operation of the outdoor door 21 (YES in S41), only the outdoor door 21 is operated. If it is difficult to reach the target temperature only by the operation of the outdoor door 21 (NO in S41), it may be determined whether to control an outdoor temperature (e.g., the temperature outdoors) through the outdoor heater 1000 provided on the end of the discharge path 600 (S42). When it is determined that the operation of the outdoor heater 1000 is required (YES in S42), it is possible to reach the set temperature through the outdoor heater 1000. In contrast, when it is determined that the operation of the outdoor heater 1000 is not required (NO in S42), only the outdoor door 21 may be operated.

As described herein, the present disclosure provides an air conditioning system for a vehicle, which allows an air conditioning function of a vehicle to be used outside the vehicle in an outdoor living environment where outdoor activities take place. The air conditioning system for a vehicle may be used outside of the vehicle by applying a structure that connects an air conditioning unit and an outdoor duct extending toward an outdoor side of the vehicle. Thus, the air conditioning system for the vehicle solves the problem of controlling the inside temperature of a tent when using a tent for outdoor activities such as camping or car camping. Furthermore, the air conditioning system may set and control air conditioning outside the vehicle using a smartphone application, making it easy to control temperature.

Although the present disclosure was described with reference to specific embodiments shown in the drawings, it should be apparent to those having ordinary skill in the art that the present disclosure may be changed and modified in various ways without departing from the spirit scope of the present inventive concept, which is described in the following claims.

What is claimed is:

1. An air conditioning system for a vehicle, the air conditioning system comprising:
an air conditioning unit that includes an introduction part that introduces air, a plurality of temperature adjustment parts that cool or heat introduced air, and a discharge part that discharges cooled or heated air to an inside of the vehicle;
an outdoor duct connected to a discharge-part side of the air conditioning unit and extending toward an outdoor side of the vehicle to discharge the cooled or heated air to an outside of the vehicle; and
an outdoor door provided on the outdoor duct or on the discharge part of the air conditioning unit around the outdoor duct to control air flow through the outdoor duct.

2. The air conditioning system of claim 1, further comprising:
a controller configured to control an operation of the outdoor door.

3. The air conditioning system of claim 2, wherein the controller opens the outdoor door to discharge the cooled or heated air through the outdoor duct to the outside of the vehicle when an operating condition is satisfied and an outdoor mode is input.

4. The air conditioning system of claim 3, wherein the operating condition comprises at least one of a vehicle starting state, a battery charging state, an air conditioning setting state, and a vehicle driving state.

5. The air conditioning system of claim 4, wherein the controller determines that the operating condition is satisfied when a state where a start of the vehicle is off, a state where the battery is charged beyond a reference value, a normal connection state with the air conditioning unit, and a vehicle parking state are all satisfied.

6. The air conditioning system of claim 2, wherein the controller closes the outdoor door to prevent the air from being discharged to the outside of the vehicle when an outdoor mode is released.

7. The air conditioning system of claim 2, wherein, when an indoor/outdoor mode is input to discharge air cooled or heated in the air conditioning unit to the inside and outside of the vehicle, the controller opens an indoor door and the outdoor door to discharge the cooled or heated air through an indoor duct or the outdoor duct to the inside and outside of the vehicle.

8. The air conditioning system of claim 2, wherein the controller determines whether to use the air conditioning unit and decides whether to monitor an indoor or outdoor temperature of the vehicle according to a determined result.

9. The air conditioning system of claim 2, wherein the controller determines a battery charging state and decides whether to issue a warning or an alarm inside the vehicle according to a determined result.

10. The air conditioning system of claim 2, further comprising:
a display part configured to display an outdoor door operation control state of the controller and an air conditioning state.

11. The air conditioning system of claim 1, further comprising:
a duct adapter configured to connect the air conditioning unit and the outdoor duct and introduce air discharged from the air conditioning unit into the outdoor duct.

12. The air conditioning system of claim 11, further comprising:
a fastening buckle provided on an end of the outdoor duct to connect the duct adapter and the outdoor duct through a fitting structure.

13. The air conditioning system of claim 1, further comprising:
a discharge path connected to an outside of the outdoor duct to extend a path through which air is discharged to the outside, and formed to adjust a discharge direction to the outside.

14. The air conditioning system of claim 13, wherein the discharge path is formed in a shape of bellows to adjust a length of the path through which air is discharged to the outside.

15. The air conditioning system of claim 13, further comprising:
an outdoor heater provided on an end of the discharge path to control a temperature outside the vehicle by reheating the air discharged to the outside of the vehicle.

16. The air conditioning system of claim 13, wherein the controller determines whether a target temperature is reached and decides whether to operate an outdoor heater according to a determined result.

17. The air conditioning system of claim 13, further comprising:
a temperature sensor provided on an end of the discharge path to measure a temperature of air discharged to the outside of the vehicle.

18. The air conditioning system of claim 17, further comprising:
a communication controller configured to communicate with the temperature sensor and control an outdoor temperature and an air volume.

19. The air conditioning system of claim 18, wherein the communication controller controls the outdoor temperature and the air volume by setting an outdoor mode or an indoor/outdoor mode depending on the temperature of air measured by the temperature sensor.

20. The air conditioning system of claim 1, further comprising:
a cowl top cover provided on the discharge-part side of the air conditioning unit and configured to have an internal space formed thereunder,
wherein the outdoor duct is connected to the discharge-part side of the air conditioning unit in the internal space when the cowl top cover is removed.
